(19) United States
(12) Patent Application Publication
(10) Pub. No.: US 2016/0161020 A1
(43) Pub. Date: Jun. 9, 2016

(54) VALVE, IN PARTICULAR AN ENGINE CONTROL VALVE, EQUIPPED WITH A METERING GATE AND A DIVERTER GATE

(71) Applicant: VALEO SYSTEMES DE CONTROLE MOTEUR, Cergy Saint Christophe (FR)

(72) Inventors: Nicolas Martin, Maisonslafitte (FR); Grégory Hodebourg, Sartrouville (FR); David Cravo, Osny (FR)

(73) Assignee: VALEO SYSTEMES DE CONTROLE MOTEUR, Cergy Saint Christophe (FR)

(21) Appl. No.: 14/783,578

(22) PCT Filed: Apr. 14, 2014
(86) PCT No.: PCT/FR2014/050903

§ 371 Date: Jan. 19, 2016

(30) Foreign Application Priority Data
Apr. 12, 2013 (FR) 1353360

(51) Int. Cl. F16K 31/528; F16K 11/052; F02M 26/71; F16K 1/22

(52) U.S. Cl. CPC F16K 31/5282; F16K 1/223; F16K 11/052; F02M 26/71

(57) ABSTRACT

The invention relates to a valve comprising: at least three channels (2, 9, 11); a metering gate (12) pivotable in a first channel (2); a diverter gate (10) that can shut off a second (9) or third (11) channel; and an actuation device (15) common to the gates (10, 12), said actuation device (15) comprising at least one actuation wheel (16) for pivoting at least one of the gates (10, 12) and having at least a first configuration in which the metering gate (12) is in a reference position in which the diverter gate (10) does not shut off the second (9) or third (11) channel. The actuation device (15) is configured such that, while in the first configuration, the rotation of the actuation wheel (16) causes the metering gate (12) to pivot in a single direction of rotation from its reference position, independently of the direction of rotation of the actuation wheel.

The invention relates to a valve, in particular an engine control valve, provided with a metering gate and a diverter gate. The metering gate is generally able to pivot in a duct to vary the gas passage section, and the diverter gate is designed to pivot between a first position shutting off a first channel and a second position shutting off a second channel. Such a valve can, for example, be placed in an exhaust gas recirculation (EGR) loop downstream from a cooler, the metering gate regulating the gas flow rate in said loop and the diverter gate being able to shut off either an access channel to said cooler, or a bypass channel bypassing the cooler. The valve can comprise a metering gate and a diverter gate controlled by an improved actuating mechanism of said gates.

Such valves exist and have already been the subject of patents. For example, patent US 2010/0199957 describes an exhaust gas recirculation valve placed upstream from a cooler, said valve having a first metering gate designed to control the gas flow rate in the EGR loop, and a second diverter gate placed downstream from said metering gate making it possible either to cause the gases to pass through the cooler, or to deviate the gases into a bypass channel in order to bypass said cooler. The main feature of said valve is that it implements an actuating mechanism that is shared by both gates. The main drawback created by such a mechanism is that it comprises a large number of parts with a particular shape, interacting with one another complexly, thus multiplying the risks of incorrect operation, or even failures.

There is a need for a valve using a metering gate and a diverter gate that can be moved by a shared actuating mechanism, making it possible to do away with the drawbacks noted in the state of the art.

The invention relates to a valve, in particular an engine control valve, comprising:
at least three channels opening into a common inner space,
a metering gate pivotable in a first channel to vary the passage section of the fluid in the latter,
a diverter gate pivotable between a position for shutting off a second channel and a position for shutting off a third channel,
a shared actuating device of the gates,
   the actuating device including at least one actuating wheel rotatable to pivot at least one of the diverter gate and the metering gate,
   the actuating device having at least one first configuration in which the metering gate is in a reference position in the first channel and in which the diverter gate is in an intermediate position in which it is not in the position shutting off the second channel or in the position shutting off the third channel, and
   the actuating device being configured so that the rotation of the actuating wheel while the actuating device is in the first configuration leads to the pivoting of the metering gate in a single and same rotation direction from its reference position, independently of the rotation direction of the actuating wheel.

In other words, irrespective of the rotation direction of the actuating wheel, from the first configuration, the metering gate always pivots in the same direction.

Such a valve has a simplified sealing mechanism for the metering gate. Indeed, by rotating in a single direction, there is then only one closing direction, and only one seal to be managed.

Such a valve only uses a single actuating wheel to pivot both gates.

The reference position can be a position in which the gate shuts off the first channel.

Within the meaning of the present application, a gate shuts off a channel when it prevents fluid from traveling in that channel.

Alternatively, the reference position can be a position in which the gate is in the fully open position of first channel.

The reference position can also be a position in which the fluid passage section in the first channel is maximal or minimal.

The actuating device can be configured so that the rotation of the actuating wheel while the actuating device is in the first configuration leads to:
according to a first phase, substantial pivoting of the diverter gate while the metering gate is only subject to slight pivoting, and
according to a second phase after the first phase, pivoting of the metering gate to alter the passage section of the fluid in the first channel without the position of the diverter gate being modified.

The actuating wheel can pivot, during the second phase, in the same rotation direction as during the first phase that immediately precedes it.

In other words, in a first phase, when the diverter gate pivots from the first configuration to a shutoff position, the metering gate is only subject to slight pivoting, from a reference position. In this way, the metering gate remains in a position close to the reference position that practically does not alter the fluid passage section in the first channel, when the diverter gate pivots to reach a shutoff position. In a second phase, the actuating wheel then continues its rotation in the same direction, the continuation of the rotation making it possible to regulate the fluid in the first channel without preventing the diverter gate from staying in the shutoff position it has reached.

Preferably, the actuating device can be configured so that the rotation of the actuating wheel while the actuating device is in the first configuration leads to:
in a first rotation direction, the pivoting of the diverter gate to the shutoff position of the second channel, and
in a second rotation direction, the pivoting of the diverter gate to the shutoff position of the third channel.

Advantageously, the actuating device can be able to keep the diverter gate in one or the other of the shutoff positions of the second or third channel, while the actuating wheel continues a unidirectional rotational movement from the first configuration.

In other words, once the diverter gate reaches a position shutting off the second or third channel, the actuating wheel can continue the rotational movement in the same direction that it had to bring the diverter gate into said shutoff position. The continuation of this rotational movement does not prevent maintenance of the diverter gate in a shutoff position.

For example, starting from the first configuration and by rotating the actuating wheel in a first rotation direction, the actuating device can
in a first phase, make it possible to pivot the diverter gate substantially to a position shutting off the second channel and pivot the metering gate slightly in a predetermined rotation direction, and
in a second, subsequent phase, and for the same rotation direction of the actuating wheel as in the preceding first phase, keep the diverter gate in the reached shutoff position, and pivot the metering gate in the predetermined rotation direction to adjust the passage section of the fluid in the first channel.

In the same example, starting from the first configuration and by rotating the actuating wheel in a second rotation direction opposite the first direction, the actuating device can
in a first phase, make it possible to simultaneously pivot the diverter gate to a shutoff position of the third channel and pivot the metering gate slightly in the predetermined rotation direction, and
in a second, subsequent phase, and for the same rotation direction of the actuating wheel as in the preceding first phase, keep the diverter gate in the reached shutoff position, and pivot the metering gate in the predetermined rotation direction to adjust the passage section of the fluid in the first channel.

Advantageously, the actuating device can comprise an actuating system of the diverter gate, said actuating system comprising a guide part and an interface part, the actuating wheel being rigidly coupled to the guide part and the diverter gate being rigidly coupled to the interface part, the guide part cooperating with the interface part to pivot the diverter gate.

The actuating device can comprise a system for actuating the metering gate, said actuating system comprising a guide member and an interface part, the actuating wheel being connected to the guide member so as to pivot the latter during its rotation, and the interface part being rigidly coupled to the metering gate, and the guide member cooperating with said interface part to pivot the metering gate.

Preferably, the guide member of the actuating system of the metering gate can comprise a first lever and a second lever articulated in rotation relative to one another, via a shared end, the first lever comprising another and cooperating by a first pivot point with the actuating wheel and the second lever comprising another end cooperating by a second pivot point with the interface part of the actuating system of the metering gate. The effect of such a guide member is to act as a connecting rod-crank system allowing pivoting of the metering gate in the same rotation direction starting from its position shutting off the first channel, irrespective of the rotation direction of the actuating wheel.

The actuating device being in the first configuration, the first and second levers can be aligned along their longitudinal axis.

The actuating device being in the first configuration, the shared end of the first and second levers can be situated on the side opposite the other end of said levers.

The actuating device being in the first configuration, the shared end of the first and second levers, the first pivot point and the second pivot point can be aligned.

Preferably, at least one part making up the guide member, in particular the first lever, of the actuating system of the metering gate and the guide part of the actuating system of the diverter gate can be separate and rigidly coupled to one another.

Alternatively, at least one part making up the guide member, in particular the first lever, of the actuating system of the metering gate and the guide part of the actuating system of the diverter gate can be formed in a single and same piece.

Advantageously, the actuating wheel cooperates with the guide part of the actuating system of the diverter gate via a first zone of said wheel and the actuating wheel is across from the shared end of the first and second levers of the guide member of the actuating system of the metering gate via a second zone of said wheel, different from the first zone.

For example, the first zone and the second zone can have different radial positions and/or different angular positions, and/or in the case where the actuating wheel has two opposite parallel faces, be positioned on different faces of said wheel.

According to a first example embodiment, the interface part of the actuating system of the diverter gate can be configured to define a guide path of the guide part with which it cooperates.

One such example embodiment is described in detail in French application no. 1,352,230, filed on Mar. 13, 2013 by the Applicant, the content of which is incorporated by reference into this application.

Advantageously, the guide path can be formed by a blind slot arranged in said interface part, said guide part resting in the blind slot when the diverter gate is in the intermediate position.

Advantageously, said guide part can exert, when it rests in the slot and under the effect of a rotation of the actuating wheel, thrust on said interface part to pivot the diverter gate.

Advantageously, the actuating system of the diverter gate can comprise a maintaining part for the interface part of said actuating system, said maintaining part being rigidly coupled with the actuating wheel.

Advantageously, said maintaining part and said interface part can comprise complementary surfaces, such that the cooperation between these complementary surfaces keeps said interface part in position during the movement of said guide part, while the diverter gate is in one or the other of the shutoff positions.

For example, said complementary surfaces can be arcs of circle with substantially the same radius.

According to another embodiment, the guide path can be formed by a guide housing arranged in the guide part of the actuating system of the diverter gate, said guide housing having two opposite lateral edges against which the guide part selectively comes into contact, when the diverter gate pivots to one or the other of the shutoff positions.

Such an example embodiment is described in detail in French application no. 1,352,229, filed on Mar. 13, 2013 by the Applicant, and the content of which is incorporated into this application by reference.

Preferably, the guide housing can comprise two segments having a shared end.

Advantageously, at each end opposite the shared end of a segment, the lateral edge of the segment closest to the other segment extends radially beyond the other lateral edge of said segment.

Advantageously, said guide part can further define a maintaining path of said interface part to maintain the diverter gate in one or the other of the shutoff positions.

Preferably, the maintaining path and the guide path can communicate by at least one shared lateral edge.

Advantageously, a spring can cooperate with the body of the valve and the interface part of the actuating system of the diverter gate, and be configured to selectively keep the diverter gate in the shutoff position.

Advantageously, the valve can be placed in a portion of an exhaust gas recirculation loop allowing all or part of the exhaust gases of a heat engine, in particular of a vehicle, to be reinjected at the intake of that engine, the valve comprising a cooler and a bypass channel bypassing said cooler, the metering gate regulating the gas flow in said exhaust gas recirculation loop, and the diverter gate shutting off either an access channel to said cooler, or the bypass channel.

The exhaust gas recirculation loop can be a high-pressure or low-pressure loop.

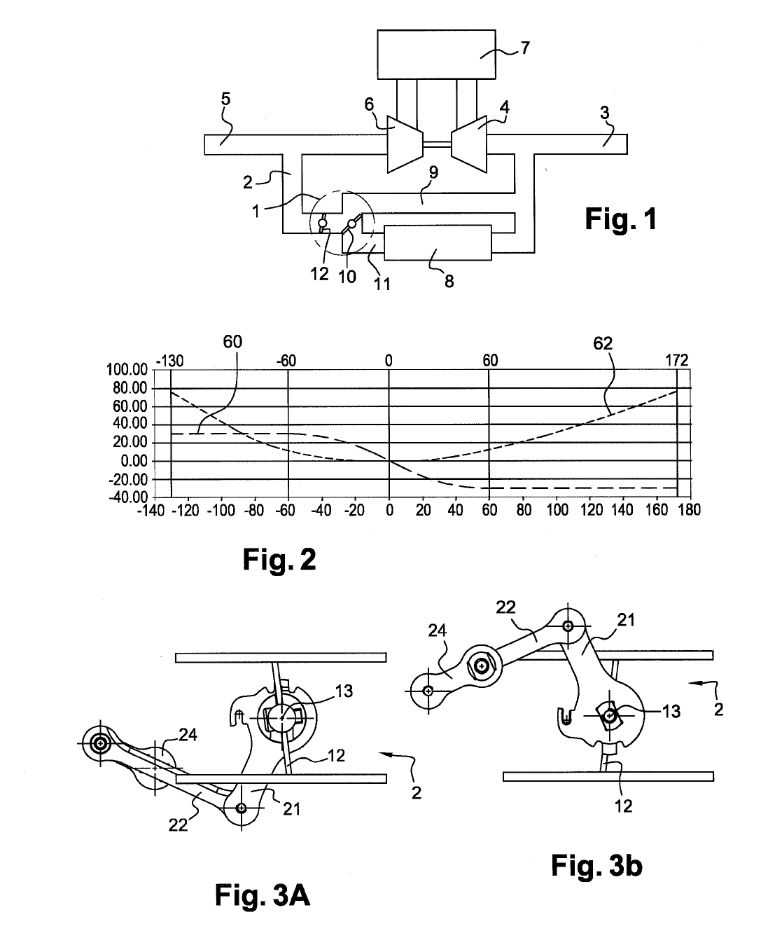

Below, a detailed description is provided of one preferred embodiment of a valve according to the invention, in reference to FIGS. 1 to 6.

FIG. 1 is a diagrammatic view of a low-pressure EGR loop in which the valve can be used.

FIG. 2 is a diagram showing the angular position of the metering gate and the diverter gate as a function of the angular position of the actuating wheel.

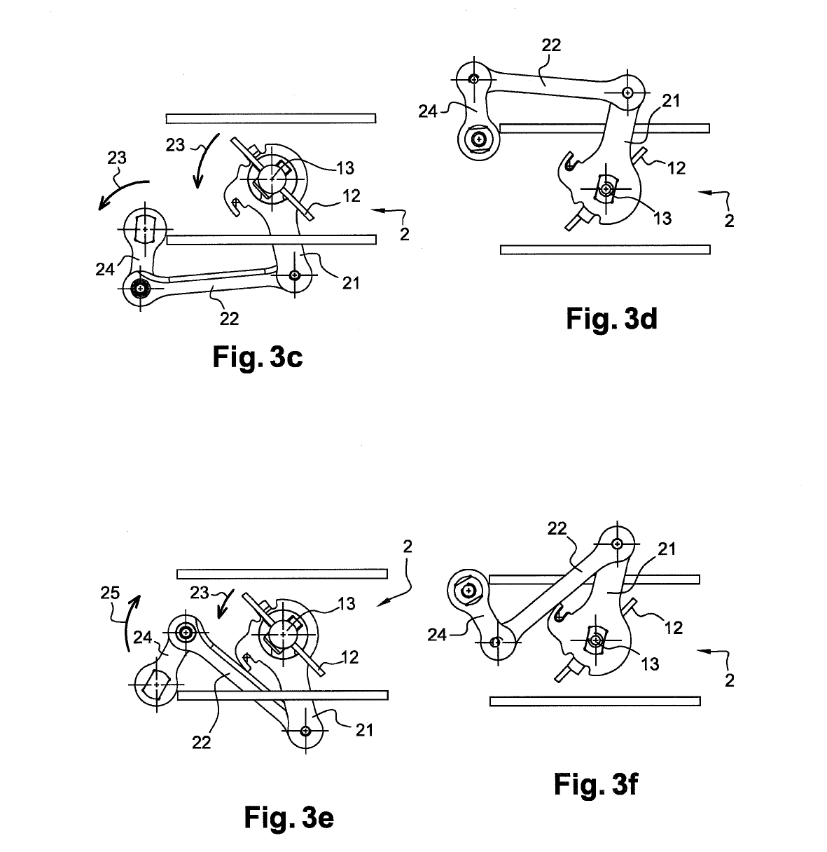

FIGS. 3a, 3c and 3e are three bottom views of the actuating device of a valve according to the invention, for three different positions of the actuating wheel of said mechanism.

FIGS. 3b, 3d and 3f are three top views, showing the operating mechanism of the metering gate according to FIGS. 3a, 3c and 3e, respectively.

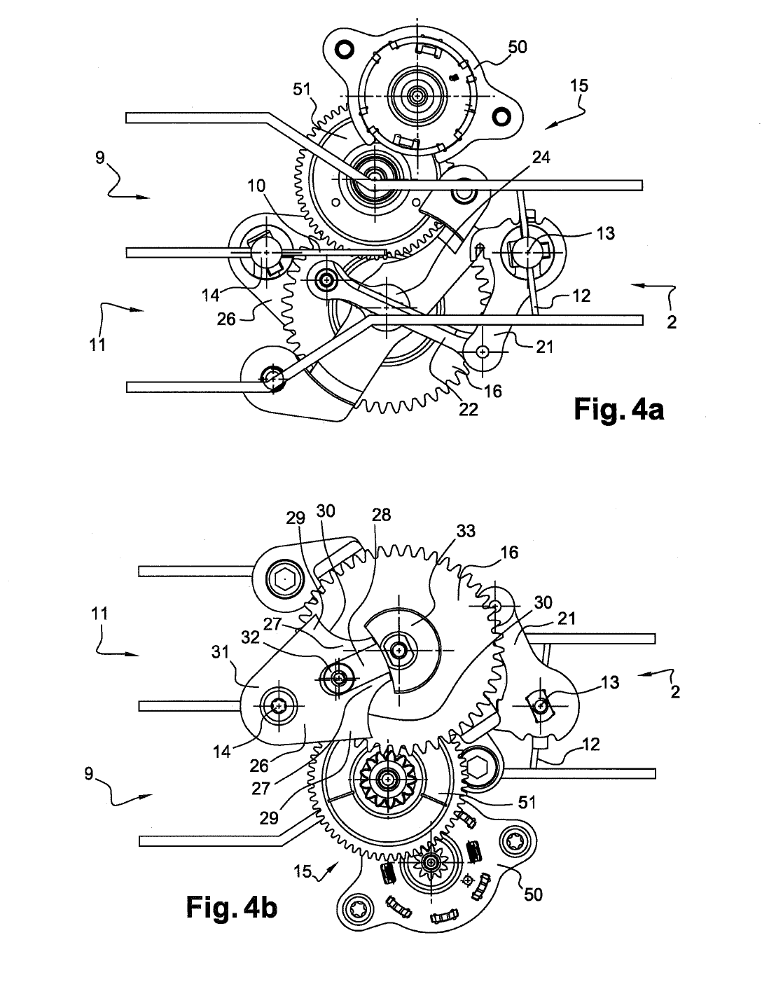

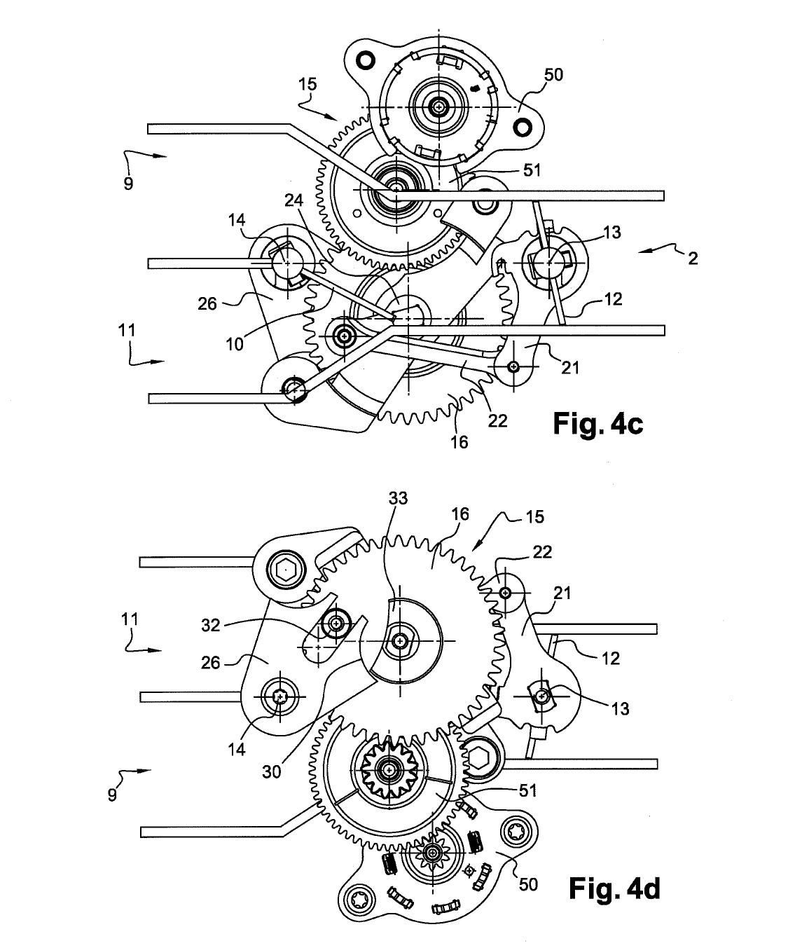

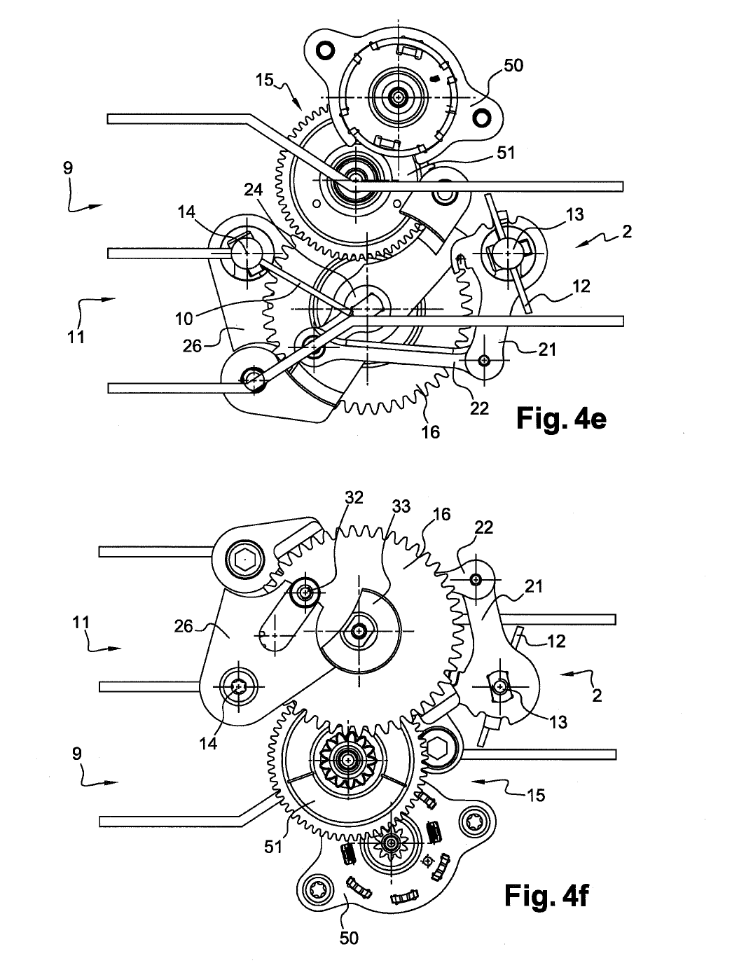

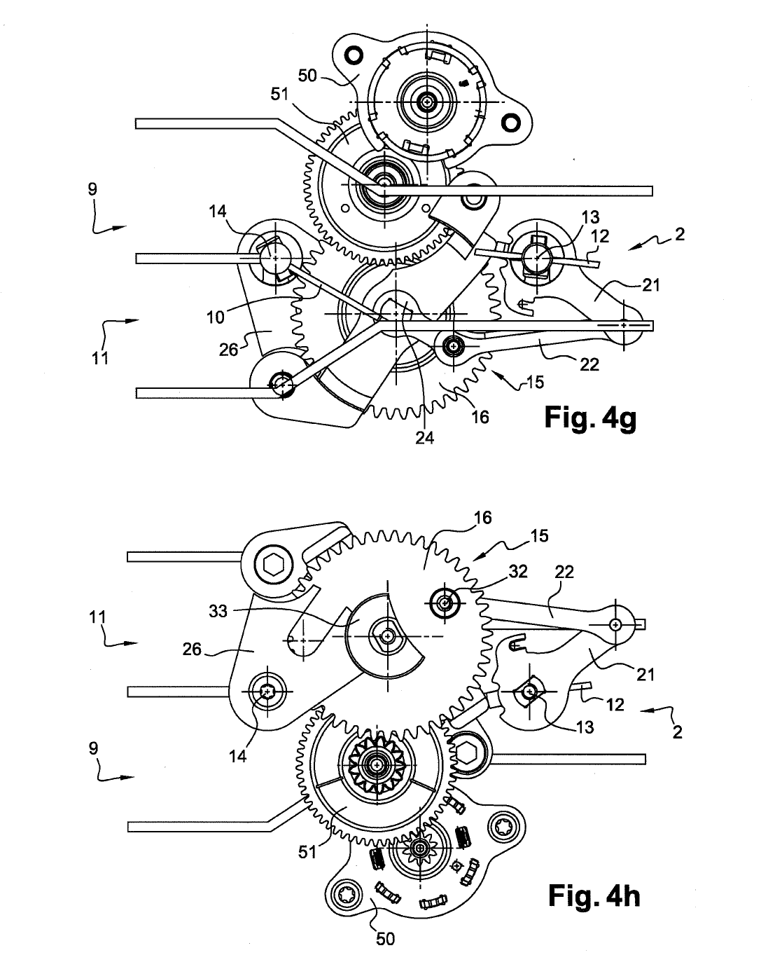

FIGS. 4a, 4c, 4e and 4g are four bottom views of the actuating device of a valve according to the invention, with four different rotational stages in the same direction of the actuating wheel, from a shutoff position of the metering gate to a completely open position of said gate, respectively.

FIGS. 4b, 4d, 4f and 4h are four top views, respectively showing the actuating device according to FIGS. 4a, 4c, 4e and 4g.

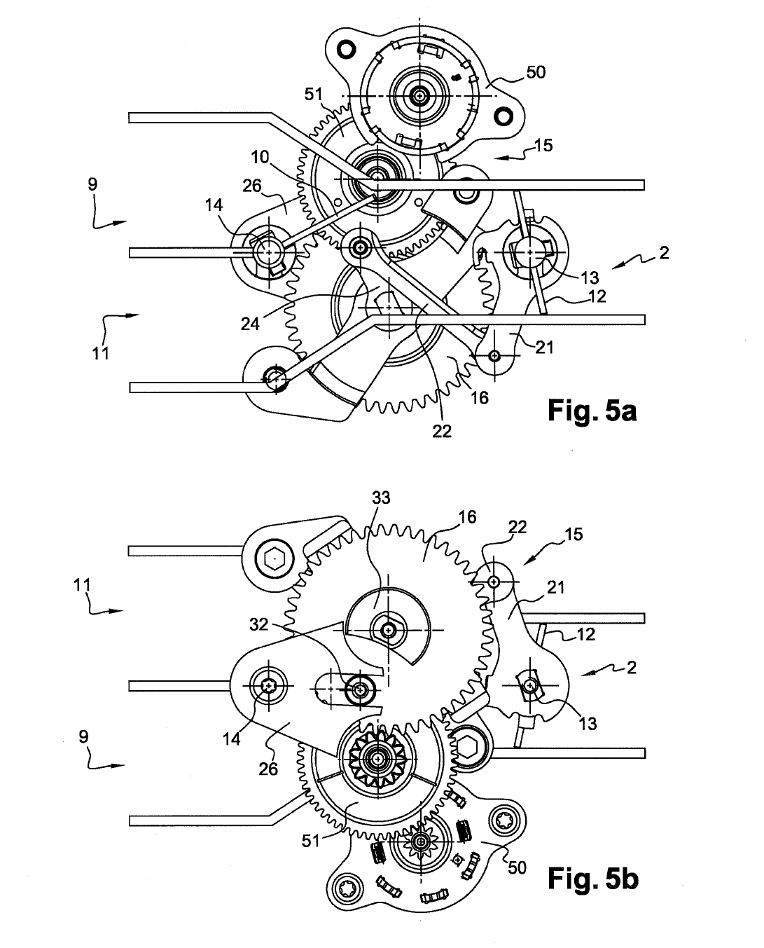

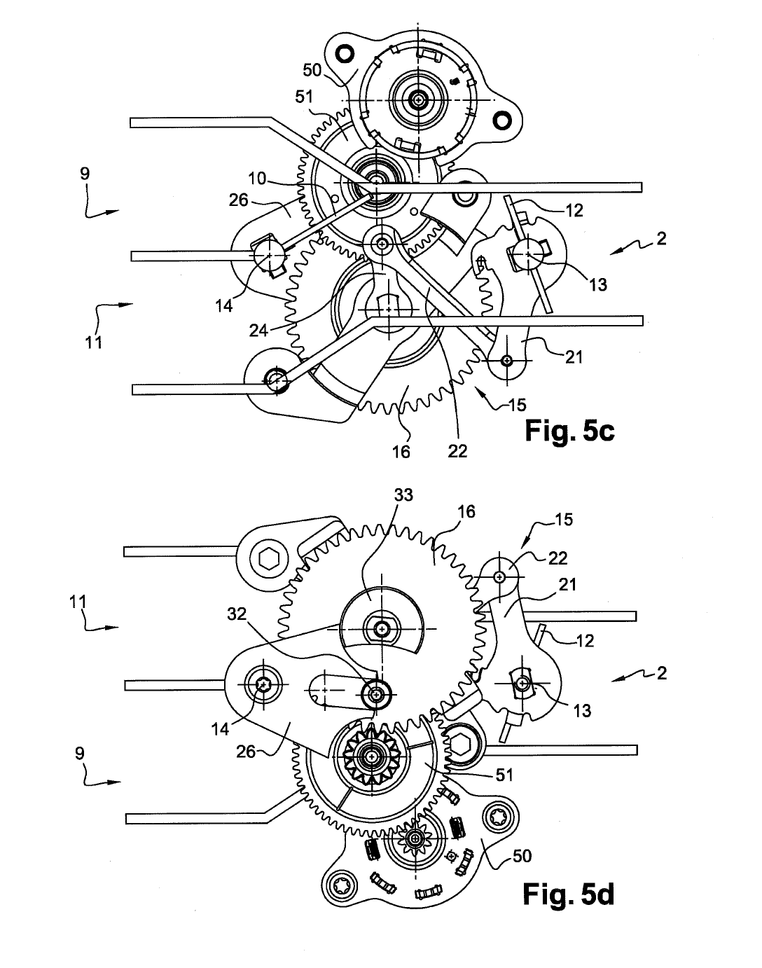

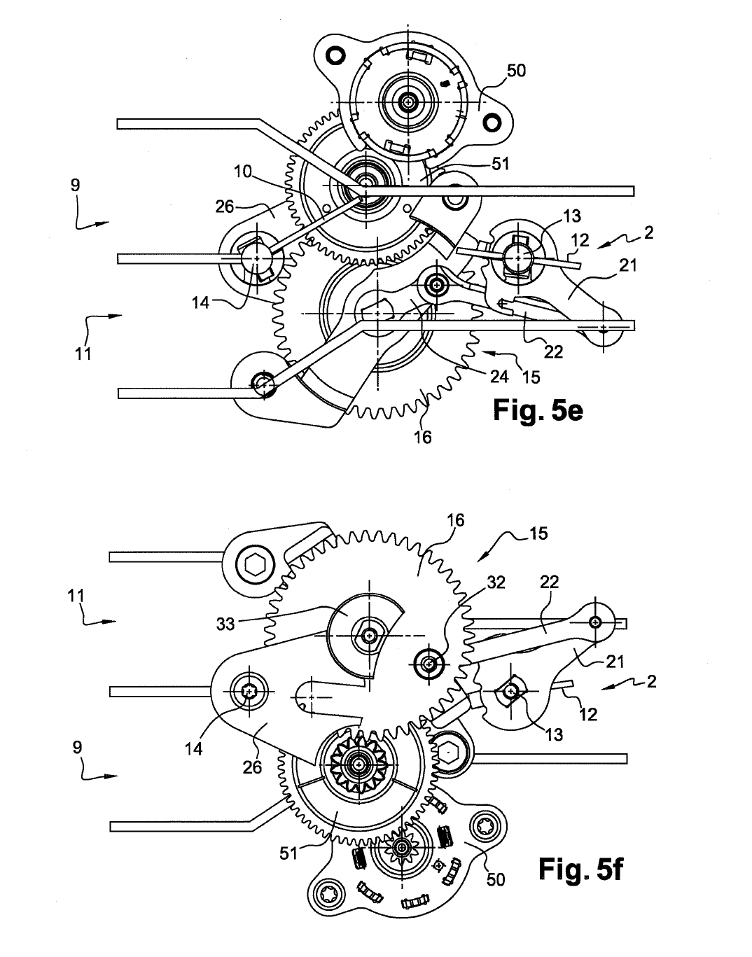

FIGS. 5a, 5c and 5e are three bottom views of the actuating device of a valve according to the invention, in three different rotational stages in the opposite direction of the actuating wheel, between a partially open position of the metering gate and a completely open position of said gate, respectively.

FIGS. 5b, 5d and 5f are three top views, respectively showing the actuating device according to FIGS. 5a, 5c and 5e.

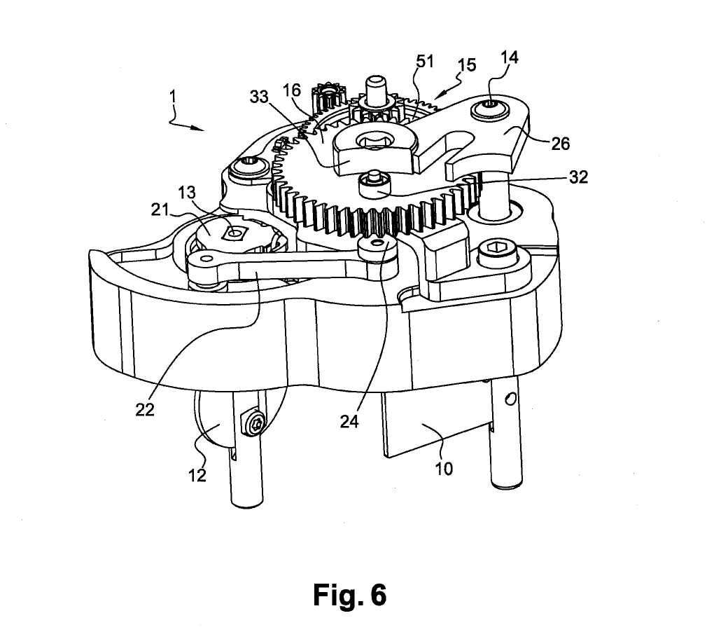

FIG. 6 is a perspective view of a valve according to the invention.

In reference to FIG. 1, a valve 1 is a low-pressure exhaust gas recirculation valve placed on an EGR loop connecting an exhaust line 3 downstream from a turbine 4 to a fresh air intake circuit 5 upstream from a compressor 6, said turbocompressor 4, 6 also traditionally being connected to a heat engine 7. The EGR loop comprises the valve 1, a recirculated gas cooler 8 and a bypass channel 9 for said gases originating upstream from said cooler 8 and emerging in an outlet channel 2 of the EGR loop, downstream from that cooler 8. The valve 1 is provided with a metering gate 12 rotatable around an axis 13, said metering gate 12 regulating the passage section of the gases in the channel 2, therefore in the EGR loop. The valve 1 also has a diverter gate 10 rotatable around an axis 14, between a first position shutting off the bypass channel 9 and a second position shutting off an access passage 11 to the cooler 8. The diverter gate 10 and the metering gate 12 are controlled in their rotational movement using a shared actuating device 15.

The actuating device 15 shared by the two gates 10, 12 includes an actuating wheel 16, able to be set in rotation in both directions by an electric motor 50 meshing on an intermediate pinion 51, the intermediate pinion 51 meshing on the actuating wheel 16. The rotation direction of said wheel 16 is dictated by the shutoff position that one wishes to assign to the diverter gate 10. This wheel 16 controls both the pivoting of the metering gate 12 and the pivoting of the diverter gate 10 using synchronized kinematics.

Thus, the actuating device 15 comprises an actuating system of the metering gate 12 and an actuating system of the diverter gate 10.

FIG. 2 shows:
on the y-axis, the angular position of the metering gate 12 and the diverter gate 10,
on the x-axis, the angular position of the actuating wheel 16.

The curve 60 shows the angular position of the diverter gate 10 and the curve 62 shows the angular position of the metering gate 12.

The different angular positions of the metering gate and the diverter gate shown in FIGS. 3a to 5f are thus visible on the curves of FIG. 2, i.e.:
FIGS. 3a, 3b, 4a and 4b for an angular position of 0° of the actuating wheel,
FIGS. 4c and 4d for an angular position of 40° of the actuating wheel,
FIGS. 4e and 4f for an angular position of 60° of the actuating wheel,
FIGS. 3c and 3d for an angular position of 120° of the actuating wheel,
FIGS. 4g and 4h, for an angular position of 120° of the actuating wheel,
FIGS. 4g and 4h, for an angular position of 172° of the actuating wheel,
FIGS. 5a and 5b, for an angular position of −40° of the actuating wheel,
FIGS. 5c and 5d, for an angular position of −60° of the actuating wheel,
FIGS. 3e and 3f, for an angular position of −100° of the actuating wheel,
FIGS. 5e and 5f, for an angular position of −130° of the actuating wheel.

The metering gate 12 is, in the considered example, in the position shutting off the outlet channel 2 of the EGR loop, when it has an angular position of approximately 0°, i.e., when the actuating wheel has an angular position of 0°.

Thus, from a first configuration of the actuating device 15 in which the wheel 16 is in a reference position at 0°, the metering gate 12 is in the position shutting off the channel 2 (angular position equal to 0°) and the diverter gate 10 is in a position in which it does not shut off the channel 9 or the channel 11 (angular position equal to 0°), setting the actuating wheel 16 in rotation in a first direction (to reach 172°) or in a second direction opposite the first direction (to reach −130°) causes:
pivoting of the metering gate 12 still in the same direction and marked by a positive maximum angular position of approximately 75°,
pivoting of the diverter gate, to respectively reach −30° or 30°.

In other words, irrespective of the rotation direction of the wheel 16 from the reference position, the metering gate 12 always pivots in the same direction with an amplitude close to 75° from the position in which it shuts off the channel 2 and the diverter gate 10 pivots in a first direction or in a second direction, to shut off one or the other of the channels 9 and 11.

Still, from the first configuration of the actuating device 15, and according to a first phase, i.e., for a passage of the actuating wheel from an angular position of 0° to an angular position of approximately 60° or −60°:
the curve 62 goes from angular position of 0° to approximately 10°, irrespective of the rotation direction of the actuating wheel,
the curve 60 goes from an angular position of 0° to approximately 30° or −30° depending on the rotation direction of the actuating wheel.

According to a second phase, i.e., for a passage of the actuating wheel from an angular position of approximately 60° to approximately 172° or from an angular position of approximately −60° to approximately −130°,
the curve 62 goes from an angular position of approximately 10° to approximately 75°, irrespective of the rotation direction of the actuating wheel,
the curve 60 stays at a value of approximately 30° or −30° depending on the rotation direction of the actuating wheel.

Thus, starting from the first configuration of the actuating device 15, a rotation in a first direction of the actuating wheel 16 to 60° causes, according to the first phase, on the one hand, an angular variation of 0° to −30° of the diverter gate 10 reflecting a pivoting in one direction to go from an open position to a shutoff position of one of the two channels 9, 11, and on the other hand, an angular variation of 0° to approximately 10° of the metering gate 12 to allow minimal opening of said gate 12 without a significant gas passage. In other words, the metering gate 12 remains in a quasi-closed position of this angular range of the actuating wheel 16. According to a second phase, when the rotation of the actuating wheel 16 continues in the first direction to reach 172°, the diverter gate 10 remains frozen in the angular position of −30°, reflecting its maintenance in the shutoff position that it has reached, whereas the annular position of the metering gate 12 varies from 10° to 75°, reflecting a gradual closure of said gate 12 until reaching a maximal open position.

Still from the first configuration of the actuating device 15, a rotation in a second direction, opposite the first direction, of the actuating wheel 16 to −60° causes diverter gate 10 to pivot from a position at 0° to a position at 30°, corresponding to the passage from an opening position to a shutoff position of the other channel 9, 11, and pivoting from a position at 0° to a position at approximately 10° of the metering gate 12 to allow minimal opening of said gate 12 without significantly altering the gas passage. In other words, relative to what was previously observed when the actuating wheel 16 was rotating in the first direction, the diverter gate 10 pivots in the first direction to shut off the other channel 9, 11, while the metering gate 12 also pivots in the first direction to become partially open. When the rotation of the actuating wheel 16 continues in the second direction to reach −130°, the diverter gate 10 remains frozen in an angular position of 30°, reflecting its maintenance in the shutoff position that it has reached, while the angular position of the metering gate 12 varies from 10° to 75°, reflecting a gradual opening of said gate 12 until reaching a maximal open position.

FIGS. 3a to 3f illustrate the actuating system of the metering gate 12, said metering gate 12 being able to pivot around its rotation axis 13. The actuating system of the metering gate 12 includes an interface part that here assumes the form of a crank 21 and that is rigidly coupled to the metering gate 12. This interface part 21 cooperates with a guide member in order to pivot the metering gate 12.

The guide member of the actuating system of the metering gate here comprises two levers 22 and 24 articulated in rotation to one another, via a shared end. The lever 24 comprises another end cooperating with the actuating wheel 16 and the other lever 22 comprises another end cooperating with the crank 21 of the actuating system of the metering gate.

A rotation of the actuating wheel 16 can thus rotate the lever 24. The lever 22 here is a rigid rod. The actuating wheel 16, the lever 22, the crank 21, the lever 24 and the metering gate 12 are placed in the space and arranged relative to one another, such that setting the actuating wheel 16 in rotation, from said reference position, in either direction, causes pivoting of the metering gate 12 still in the same direction by means of the lever 22.

FIGS. 3a and 3b show the metering gate 12 in the reference position. FIGS. 3c and 3d show the metering gate 12 after the actuating wheel 16 has rotated to reach an angular position of 120°, i.e., in the first rotation direction embodied by the arrow 23 in FIG. 3a. FIGS. 3e and 3f show the metering gate 12 after the actuating wheel 16 is rotated to reach an angular position of −100°, i.e., along the second rotation direction opposite the first direction and embodied by the arrow 25 in FIG. 3e.

Thus, irrespective of the rotation direction of the actuating wheel 16 from the reference position, the crank 21, therefore the metering gate 12, pivots in the same rotation direction, in the case at hand, the direction embodied by the arrow 23 in FIGS. 3c and 3e.

Although not shown in FIGS. 3c to 3f, continuing to rotate the actuating wheel 16 in either direction would accentuate pivoting of the metering gate 12 around its axis 13 still in the same direction so as to increase its opening.

FIGS. 4a to 4h, and 5a to 5f, illustrate the actuating system of the metering gate 12 and the actuating system of the diverter gate 10.

In these figures, the actuating system of the metering gate 12 is shown in the same way as in FIGS. 3a to 3f.

The actuating system of the diverter gate 10 is a mechanism of the “Maltese cross” type, the principle of which is based on discontinuously setting an object in the shape of a Maltese cross in rotation using a continuous rotation of a driving part interacting with said object. In the context of the invention, said actuating system includes a Maltese cross-shaped object that is an interface part 26 secured to the gate 10. This interface part 26 comprises two parallel arms 27 arranging a slot 28 between them defining a guide path, as will be seen below, and two lateral protuberances 29, each of said protuberances 29 being placed on each side of the longitudinal axis of the slot 28.

An arm 27 and a protuberance 29 placed on the same side relative to the longitudinal axis of the slot 28 are connected to one another by an arc of circle-shaped surface 30. The interface part 26 has a base 31 aligned on the longitudinal axis of the slot 28, the axis connecting the two protuberances 29 separating said base 31 and the two arms 27. In this way, each arm 27 has an end implanted in the base 31, and another end that is free. The gate 10 has a rotation axis 14 allowing it to pivot between the two shutoff positions of the two channels 9, 11, the interface part 26 being rigidly fixed to one end of the gate 10 by means of said base 31. More specifically, the interface part 26 is fixed to the gate 10 such that the base 31 of the interface part 26 is crossed through by the rotation axis 14 of the gate 10. Thus, the rotation of the interface part 26 simultaneously causes the rotation of the gate 10 around its rotation axis 14 with the same angle.

Aside from the interface part 26, the actuating system of the diverter gate 10 comprises a guide part 32, here a lug attached on the actuating wheel 16 and on which a ball bearing cooperates in the described example. The lug 32 is for example cylindrical and placed on the periphery, and emerges from the plane of the actuating wheel 16 in a perpendicular direction.

The actuating system of the diverter gate 10 also comprises a maintaining part 33 that here is a fraction of another wheel coaxial with the actuating wheel 16, and secured thereto. This other wheel 33 is positioned in the central zone of the actuating wheel 16. The other wheel 33 emerges from the plane of the wheel 16 in a perpendicular direction, and thus creates an overthickness. The cross-section of the other wheel 33, which is perpendicular to its rotation axis, has a circular contour over more than half of its circumference, as well as a recess delimited by a curved segment connecting the partial circular contour to close said section.

In reference to FIGS. 4a and 4b, when the actuating wheel 16 is in a reference position corresponding to the first configuration of the actuating device 15, the lug 32 of the actuating wheel 16 is positioned at the bottom of the slot 28. The two arms 27 of the interface part 26 then occupy the hollow left vacant by the maintaining part 33, their free end striking off the curved segment of said maintaining part 33.

In reference to FIGS. 4c to 4h, the actuating wheel 16 rotates gradually in the direction embodied by the arrow 23 in FIG. 3c, that rotation direction being representative of the bottom views, i.e., FIGS. 4c, 4e and 4g. FIGS. 4c and 4d, 4e and 4f, 4g and 4h show the state of the gates 10 and 12 for angular positions of the actuating wheel at the values of 40°, 60° and 172°, respectively.

In reference to FIGS. 4c and 4d, when the wheel 16 is set in rotation, in the embodied direction, for the bottom view, by the arrow 23 in FIG. 3c, from its reference position, the lug 23 causes the rotation of the interface part 26 and therefore of the diverter gate 10 secured to it, by exerting thrust on one of the two arms 27 bordering the slot 28.

In reference to FIGS. 4e and 4f, the gate 10 reaches the position shutting off the channel 11.

In reference to FIGS. 4g and 4h, once the diverter gate 10 has reached its position shutting off the channel 11, the actuating wheel 16 can continue its rotation such that an arc of circle-shaped segment 30 of the interface part 26 bears against the maintaining part 33, and more specifically against the outer surface of the cylindrical portion of said part 33. This maintaining part 33 contributes to keeping the diverter gate 10 in a position shutting off the channel 11, by bearing against an arc of circle-shaped segment 30 of the interface part 26.

In reference to FIGS. 5a to 5f, the actuating wheel 16 can also be set in rotation in the opposite direction from its reference position, i.e., in the direction embodied by the arrow 25 in FIG. 3e, that rotation direction being representative of the bottom views, i.e., FIGS. 5a, 5c and 5e, so as to allow the diverter gate 10 to shut off the channel 9. Everything previously described regarding the pivoting kinematics of the diverter gate 10 to shut off the channel 11 also remains valid when said gate 10 shuts off the channel 9.

The actuating device 15 described above combines the actuating system of the metering gate 12 and the actuating system of the diverter gate 10 previously described, according to synchronized kinematics, in order to best optimize the pivoting conditions of metering gate 12 and the diverter gate 10.

FIGS. 4a and 4b show bottom and top views, respectively, of the first configuration of the actuating device 15.

In reference to FIGS. 4c and 4d, the first phase of the rotation of the actuating wheel 16 in one direction, from its reference position, makes it possible to simultaneously pivot the diverter gate 10, so that it comes into a position shutting off the channel 11, and the metering gate 12, so that it is slightly open while allowing an insignificant gas passage in the channel 2.

Thus, the rotation of the diverter gate 10 to this position shutting off the channel 11 is done while the metering gate 12 remains in a quasi-closed position of the channel 2.

In reference to FIGS. 4e and 4f, the diverter gate 10 reaches the position shutting off the channel 11.

In reference to FIGS. 4g and 4h, the actuating wheel 16 continues, according to the second phase, its rotation in the same direction, in order to gradually open the metering gate 12 to regulate the passage of recirculated gases in the channel 2, while keeping the diverter gate 10 in its shutting off position, owing to the maintaining part 33 of the actuating wheel 16, against which the interface part 26 bears. The opening of the metering gate 12 is done by pivoting the metering gate 12 around its axis 13, and allows the gases to flow in the outlet channel 2 of the EGR loop.

The rotation of the actuating wheel 16 can continue, still in the same direction, until the metering gate 12 reaches a maximal open position to allow the exhaust gases to pass in the channel 2 with a maximal flow rate. Thus, the adjustment of the opening degree of the metering gate 12 is done by pivoting of said metering gate 12 controlled by the actuating wheel 16, while the diverter gate 10 remains in a position shutting off the channel 11. At any time, the actuating wheel 16 can be set in rotation in the opposite direction to adjust the opening position of the metering gate 12 by reducing the gas flow rate in the channel 2.

In reference to FIGS. 5a and 5b, the rotation of the actuating wheel 16 in the opposite direction, starting from the first configuration of the actuating device 15, makes it possible, according to the first phase, to simultaneously pivot the diverter gate 10, so that it comes into a position shutting off the channel 9, and the metering gate 12, so that it pivots slightly while allowing an insignificant gas passage in the channel 2. In that case, the diverter gate 10 pivots in a direction opposite that in which it pivots in the example described in reference to FIGS. 4a to 4e, to shut off the channel 11, while the metering gate 12 still pivots in the same direction as that in which it pivots in the example described in reference to figures a4 to 4e, so as to open slightly.

In reference to FIGS. 5c and 5d, the diverter gate 10 reaches the position shutting off the channel 9.

In reference to FIGS. 5e and 5f, the actuating wheel 16 continues, according to the second phase, its rotation in the same direction, in order to gradually open the metering gate 12 to regulate the recirculated gas passage in the channel 2, while keeping the diverter gate 10 in its position shutting off the channel 9, owing to the maintaining part 33 of the actuating wheel 16, against which the interface part 26 bears. The metering gate 12 is opened by pivoting of said gate 12 around its axis 13, and allows the gases to penetrate the channel 2 with a predefined flow rate.

The rotation of the actuating wheel 16 can continue, still in the same direction, until the metering gate 12 has reached a maximal open position to allow the exhaust gases to pass in the channel 2 with a maximal flow rate. Thus, the adjustment of the opening degree of the metering gate 12 is done by pivoting of said metering gate 12, controlled by the actuating wheel 16, while the diverter gate 10 remains in a position shutting off the channel 9. At any time, the actuating wheel 16 can be set in rotation in the direction opposite that which moves it from the first configuration to adjust the opening position of the metering gate 12 while reducing the flow rate of the gases in the channel 2.

FIG. 6 is a perspective view of the valve 1 according to the invention. The valve is shown in a configuration in which the angular position of the actuating wheel 16 is approximately 135°, i.e., the diverter gate 10 is in the position shutting off the channel 11 and the metering gate 12 has an angular position of approximately 50°. The interface part 26, the guide part 32 and the maintaining part 33, in the example in question making up the actuating system of the diverter gate 10, are situated across from a first face of the actuating wheel 16. The crank 21 and the levers 24 and 22 making up, in the considered example, the actuating system of the metering gate 12 are situated across from a second face, opposite the first face, of the actuating wheel 16.

1. An engine control valve, comprising:
at least three channels opening into a common inner space;
a metering gate pivotable in a first channel to vary the passage section of the fluid in the latter;
a diverter gate pivotable between a position for shutting off a second channel and a position for shutting off a third channel;
a shared actuating device of the gates (10, 12),
the actuating device including at least one actuating wheel rotatable to pivot at least one of the diverter gate and the metering gate,
the actuating device having at least one first configuration in which the metering gate is in a reference position in the first channel and in which the diverter gate is in an intermediate position in which it is not in the position shutting off the second channel or in the position shutting off the third channel, and
the actuating device being configured so that the rotation of the actuating wheel while the actuating device is in the first configuration leads to the pivoting of the metering gate in a single and same rotation direction from its reference position, independently of the rotation direction of the actuating wheel.

2. The valve according to claim 1, the actuating device being configured so that the rotation of the actuating wheel while the actuating device is in the first configuration leads to:
according to a first phase, substantial pivoting of the diverter gate while the metering gate is only subject to slight pivoting, and
according to a second phase after the first phase, pivoting of the metering gate to alter the passage section of the fluid in the first channel without the position of the diverter gate being modified.

3. The valve according to claim 1, the actuating device being configured so that the rotation of the actuating wheel while the actuating device is in the first configuration leads to:
in a first rotation direction, the pivoting of the diverter gate to the shutoff position of the second channel, and
in a second rotation direction, the pivoting of the diverter gate to the shutoff position of the third channel.

4. The valve according to claim 1, the actuating device being able to keep the diverter gate in one or the other of the shutoff positions of the second or third channel, while the actuating wheel continues a unidirectional rotational movement from the first configuration.

5. The valve according to claim 1, the actuating device comprising an actuating system of the diverter gate, said actuating system comprising a guide part and an interface part, the actuating wheel being rigidly coupled to the guide part and the diverter gate being rigidly coupled to the interface part, the guide part cooperating with the interface part to pivot the diverter gate.

6. The valve according to claim 1, the actuating device comprising a system for actuating the metering gate, said actuating system comprising a guide member and an interface part, the actuating wheel being connected to the guide member to pivot the latter during its rotation, and the interface part being rigidly coupled to the metering gate, and the guide member cooperating with said interface part (21) to pivot the metering gate.

7. The valve according to claim 5, the guide member of the actuating system of the metering gate comprising a first lever and a second lever articulated in rotation relative to one another, via a shared end, the first lever comprising another and cooperating by a first pivot point with the actuating wheel and the second lever comprising another end cooperating by a second pivot point with the interface part of the actuating system of the metering gate.

8. The valve according to claim 7, the actuating wheel cooperating with the guide part of the actuating system of the diverter gate via a first zone of said wheel and the actuating wheel being across from the shared end of the first and second levers of the guide member of the actuating system of the metering gate via a second zone of said wheel, different from the first zone.

9. The valve according to claim 7, the shared end of the first and second levers, the first pivot point and the second pivot point being be aligned when the actuating device is in the first configuration.

10. The valve according to claim 5, the interface part of the actuating system of the diverter gate being configured to define a guide path of the guide part with which it cooperates.

11. The valve according to claim 10, the guide path being formed by a blind slot arranged in said interface part, said guide part resting in the blind slot when the diverter gate is in the intermediate position.

12. The valve according to claim 11, said guide part exerting, when it rests in the slot and under the effect of a rotation of the actuating wheel, thrust on said interface part to pivot the diverter gate.

13. The valve according to claim 10, the actuating system of the diverter gate comprising a maintaining part for the interface part of said actuating system, said maintaining part being rigidly coupled with the actuating wheel.

14. The valve according to claim 13, said maintaining part and said interface part comprising complementary surfaces, such that the cooperation between these complementary surfaces keeps said interface part in position during the movement of said guide part, while the diverter gate is in one or the other of the shutoff positions.

15. The engine control valve according to claim 1, being placed in an exhaust gas recirculation loop comprising a cooler and a bypass channel bypassing said cooler, and the metering gate regulating the gas flow in said exhaust gas recirculation loop, the diverter gate shutting off either an access channel to said cooler, or said bypass channel.
